(19) United States
(12) Patent Application Publication
(10) Pub. No.: US 2014/0261329 A1
(43) Pub. Date: Sep. 18, 2014

(54) DIAPHRAGM CARBURETOR WITH FUEL METERING COMPENSATION

(71) Applicant: WALBRO ENGINE MANAGEMENT, L.L.C., Tucson, AZ (US)

(72) Inventors: Matthew A. Braun, Caro, MI (US); Gary J. Burns, Fostoria, MI (US)

(73) Assignee: WALBRO ENGINE MANAGEMENT, L.L.C., Tucson, AZ (US)

(21) Appl. No.: 14/196,543

(22) Filed: Mar. 4, 2014

Related U.S. Application Data
(60) Provisional application No. 61/783,024, filed on Mar. 14, 2013.

(51) Int. Cl. F02M 17/10

(52) U.S. Cl. CPC F02M 17/10
USPC 123/446

(57) ABSTRACT

A fuel and air supply device for an engine includes a carburetor having a fuel metering assembly with a fuel metering diaphragm defining at least part of a reference chamber, a scavenging air assembly including an air passage and an air valve moveable within the passage to alter air flow through the air passage, and a reference passage. The reference passage communicates at one end with the air passage upstream of the air valve and at its other end with the reference chamber to provide a reference air signal through the reference passage to the reference chamber. The reference air signal, in at least some implementations, is taken from a location downstream of an air filter and any other components so it is representative of the air flow at the air valve and accounts for restrictions to air flow caused upstream of the air valve.

### REFERENCE TO CO-PENDING APPLICATION

This application claims the benefit of U.S. Provisional Application No. 61/783,024 filed Mar. 14, 2013, which is incorporated herein by reference in its entirety.

### TECHNICAL FIELD

The present disclosure relates generally to a carburetor for a stratified scavenged engine.

### BACKGROUND

A carburetor is used to provide a combustible charge or mixture of fuel and air to an internal combustion engine. The carburetor meters liquid fuel for mixing with air to adjust a fuel-to-air ratio, according to varying engine requirements during engine startup, idle, steady-state operation, and changes in load and altitude.

A diaphragm-type carburetor is typically used with small two-stroke internal combustion engines commonly used in hand-held power tools such as chain saws, weed trimmers, leaf blowers, and the like. In the diaphragm carburetor, a body defines a mixing passage with an air inlet and a downstream fuel-and-air mixture outlet. A throttle valve is disposed in the fuel-and-air mixing passage downstream of the air inlet for controlling delivery of a primary fuel-and-air mixture to the engine. A typical diaphragm fuel metering system includes a metering valve, and a flexible diaphragm carried by the body and partially defining and separating a fuel chamber from the atmosphere. The metering valve and diaphragm control fuel flow from the diaphragm fuel pump to the fuel chamber for delivery from the fuel chamber to the fuel-and-air mixing passage.

A scavenging-type of diaphragm carburetor may be used with some engines to reduce scavenging losses or blow-through of some of the fuel-and-air mixture out of engine exhaust ports. A scavenging carburetor is known to have a fuel-and-air mixture passage and a separate scavenging air passage that both communicate at one end of the carburetor with a clean air source at atmospheric pressure, such as an air filter.

### SUMMARY

In at least some implementations, a fuel and air supply device for an engine includes a carburetor having a fuel metering assembly including a fuel metering diaphragm that defines at least part of a reference chamber, a scavenging air assembly including an air passage and an air valve within the passage and moveable to alter air flow through the air passage, and a reference passage. The reference passage communicates at one end with the air passage at a location upstream of the air valve and at its other end with the reference chamber to provide a reference air signal through the reference passage to the reference chamber. The reference air signal, in at least some implementations, is taken from a location downstream of an air filter and any other components so it is representative of the air flow at the air valve and accounts for restrictions to air flow caused upstream of the air valve.

In at least some implementations, a fuel and air supply device for an engine includes a fuel and air mixing passage from which a fuel and air mixture is delivered to an engine, a fuel metering assembly including a fuel metering diaphragm that defines at least part of a reference chamber, a scavenging air assembly including an air passage through which a supply of air is provided to an engine, a filter through which air flows to the air passage, and a reference passage. The reference passage communicates at one end with a location downstream of the filter at its other end with the reference chamber. This provides a reference air signal to the reference chamber that accounts for restrictions to airflow caused by the filter.

### BRIEF DESCRIPTION OF THE DRAWINGS

The following detailed description of preferred embodiments and best mode will be set forth with reference to the accompanying drawings, in which:

FIG. 1 is a cross-sectional view of a stratified scavenging diaphragm carburetor with an air valve carried by a main carburetor body and showing a fuel circuit of the carburetor;

FIG. 2 is perspective rear view of a carburetor and a stratified scavenging air assembly spaced from the carburetor;

FIG. 3 is a front view of a housing for an air filter that is mounted upstream of the carburetor and air valve of FIG. 2; and

FIG. 4 is a perspective view of a carburetor including a stratified scavenging air assembly and showing a plurality of possible air compensator passages leading to a metering assembly of the carburetor.

### DETAILED DESCRIPTION OF PREFERRED EMBODIMENTS

Referring in more detail to the drawings, FIG. 1 illustrates a diaphragm-type carburetor 10 for a stratified and air scavenged internal combustion engine. The carburetor 10 has a scavenging air assembly 12 through which flows air preferably from a clean air source, such as an air filter 14, through a butterfly-type control valve 16 disposed in an air passage 18 and to the combustion chamber of an engine. A body 22 of the scavenging air assembly 12 may be attached to one end of a main body 24 of the diaphragm carburetor 10.

The carburetor 10 may include a fuel-and-air mixing passage 26 defined by the body 24 into which fuel is supplied by one or more fuel circuits and where the fuel is mixed with air flowing from the filter 14 through the passage 26. The fuel and air mixture flows past a butterfly-type throttle valve 32 disposed in or in communication with the fuel and air mixing passage 26 and into the crankcase of the engine. A choke valve 33 may be provided upstream of the throttle valve 32 in another location within or upstream of the fuel and air mixing passage 26.

The carburetor may include a fuel pump assembly 37 that supplies fuel to a fuel metering assembly 28, as is known in the art. Fuel flows from the fuel pump assembly 37 into a fuel metering chamber 38 of the fuel metering system 28 through a valve (not shown) that is opened and closed by flexing or displacement of a fuel metering diaphragm 40. The fuel metering chamber 38 is defined at least in part between a first side of the diaphragm 40 and the carburetor body 24, and a reference chamber 42 is defined between an opposite side of the diaphragm 40 and a cover plate 43 attached to the body. A pressure within the reference chamber 42 acts on the diaphragm and helps to ensure a relatively constant pressure of fuel in the fuel metering chamber. In use, when the operating engine is idling (and the throttle valve 32 is substantially closed), fuel is supplied from the metering chamber 28 to the mixing passage 26 through idle or low speed ports 45, and when the throttle valve 32 is substantially opened (and thus the engine is operating at high speed and/or load conditions), fuel is supplied to the mixing passage 26 primarily through the main or high speed fuel nozzle 46.

To account for restrictions to the air flowing to the carburetor, such as may be caused by the air filter 14, the reference chamber 42 of the fuel metering assembly 28 is communicated with a location downstream of the air filter 14. In at least some implementations, the reference chamber 42 may be communicated with a location downstream of the air filter 14 and upstream of the air valve 16. In this way, a restriction and pressure drop that may be caused by the air filter 14, particularly as the air filter becomes increasingly clogged or dirty in use, can be communicated with the fuel metering assembly 28 to alter the operation of the fuel metering assembly 28 as a function of the air flow through the air filter 14. Therefore, the carburetor 10 can provide a fuel and air mixture to the engine that has a desired air-fuel ratio even as the filter 14 becomes dirtier over time and as the air flow rate through the filter changes.

As shown in FIG. 1, the reference chamber 42 may be communicated with a portion of the air passage 18 of the scavenging air assembly 12 that is downstream of the filter 14 and upstream of the air valve 16, such as by a reference passage 44. The reference passage 44 is schematically shown in FIG. 1 by a dashed line, and may be defined by or include one or more external tubes, internal passages or chambers formed or drilled in the scavenging air body 22 and/or carburetor body 24, or a combination of internal and external features that extend between the air passage 18 and the reference chamber 42.

Certain representative examples of reference passages will be described below with regard to other carburetors. The carburetors described below may be of the same general construction as that previously described, and so the description of the carburetors that follows generally will only focus on the differences in the carburetors and will not include a full description of their construction. Further, the same reference numbers may be used among the carburetors where the components are the same or similar, for ease and clarity of description. However, use of a different reference number for similar components among different carburetors does not mean that the exact same component cannot be used in the different carburetors.

FIG. 2 illustrates a carburetor 60 and a scavenging air assembly 62 that is not directly carried by the carburetor 60. In this implementation, the reference passage 44 includes a flexible conduit 66 that is connected at one end to a tap 68 that communicates with the air passage 18 and at its other end to a tap 70 that communicates with the reference chamber (not shown, but beneath the cover plate 43) of the carburetor fuel metering assembly. The conduit 66 is routed externally of the scavenging air assembly 62 and the carburetor 60. The taps 68, 70 may include barbed fittings onto which the ends of conduit 66 are fitted. The taps 68, 70, or the reference passage if taps are not provided, could include an inlet tube 72 or snorkel that extends into the air passage 18 rather than merely being a port or orifice formed in a sidewall of the air passage 18. This may improve air flow into the reference passage 66 to better communicate with the reference chamber 42. To further improve air flow, a dista, open end 73 of the inlet tube 72 may be beveled or otherwise angled to provide a larger open area into which air may flow, and the tube itself can be oriented in the air passage 18 for a desired air flow. In the implementation shown, the conduit 66 is formed of a flexible polymeric material. Of course, the conduit 66 could be rigid instead of flexible, could be formed of metal and/or a polymer, and could be otherwise routed.

FIG. 3 illustrates a portion of a housing 74 that may carry an air filter 14 upstream of a scavenging air assembly 62 and a carburetor 60. The filter housing 74 may include a passage 76, orifice or other feature through which air may flow and with which may be communicated an air reference passage such as the conduit 66 of FIG. 2. The filter housing passage 76 may lead to the air passage 16, and the reference passage 66 may be communicated with the air passage 16, as previously described.

FIG. 4 illustrates a carburetor 80 like that shown in FIG. 1, where a scavenging air assembly 82 is carried by a body 84 that is attached to the carburetor body 86. A first reference passage 88 in this example may be completely internal, that is, defined by one or more drilled/formed passages and/or chambers and/or ports leading from a port 89 (open to the air passage 18) to the reference chamber, through the scavenging air body 84, and one or both of the carburetor body 86 and a cover plate 43 that defines part of the reference chamber (not shown, but beneath the cover 43). If desired, an inlet tube 92, like that described with reference to FIG. 2, can be oriented in the air passage 18 and may lead to and define part of a second reference passage 94 which may also communicate with the reference chamber either separately from or conjointly with the reference passage 88. FIG. 4 also shows an externally routed reference passage 96, that may be defined in a conduit as described with reference to FIG. 2.

Of course, more than one reference passage may be used in a carburetor, if desired, where each passage may be internal, external or a combination of the two. The three passages 88, 94, 96 could be used together, in any combination of two, or only one might be used in a given carburetor. When multiple reference passages are used, they may communicate at one or both ends independently or conjointly with the air passage or reference passage. That is, the reference passages may be independent from each other, or they may be communicated with each other, i.e., joined or merged between the air passage and reference chamber.

The reference passage(s) in any implementation may communicate with the air passage 18 at any desired location, which may open to any axial, circumferential and radial location of the air passage that is desired. For example, the reference passage 88 opens into the air passage 18 at a location that is axially inwardly spaced and circumferentially spaced in the air passage 18 relative to the location at which the reference passage 96 opens into the air passage 18 (where the axis of the air passage 18 is used as the reference for the terms radial, axial and circumferential). And the reference passage 94 includes the inlet tube 92 so its location of communication with the air passage 18 is radially inwardly spaced relative to the other reference passages 88, 94 which open to the air passage 18 via ports in the sidewall of the air passage body 84.

The various reference passage arrangements may facilitate routing the reference passages from the air passage 18 to the reference chamber, and/or could be used to tune or synchronize phasing of the signal provided through the reference passage(s) to the reference chamber. The air flow rate and timing and magnitude of engine pressure pulses can vary at different locations within the air passage so the system can be tuned for a desired performance during at least some of the engine operating conditions. Further, the length of the reference passage(s), number of turns, radius or sharpness of the turns, material of the passage(s), direction that an inlet of the reference passage(s) is facing (e.g. an inlet tube may be oriented and/or bent so that its inlet is facing in any desired direction such as into or away from the air flow, or any angle in between), and still other factors may be calibrated to provide a desired reference signal to the reference chamber. And the reference pressure signal may be timed or synchronized to provide a desired performance during at least some engine operating conditions. To provide further control, a valve may be provided to selectively close off one or more reference passages where more than one reference passage is provided. The valve could be electrically driven and controlled, with one example being a solenoid valve. This may enhance control of the pressure within the reference chamber. If desired, a calibrated vent/bleed opening may be provided through the cover 43 to communicate the reference chamber with the atmosphere and that may provide a controlled attenuation of the reference signal pressure.

Next, referring again to FIG. 1, the signal provided to the reference chamber 42 may also be controlled as a function of the surface area of the fuel metering diaphragm 40 exposed to the reference chamber 42 and the minimum flow area/restriction in the reference passage 44 between the inlet of the reference passage (communicating with a location downstream of the filter and upstream of the air valve) and the outlet of the reference passage which opens to the reference chamber 42. In at least some implementations, a ratio of the surface area of the diaphragm 40 exposed to the reference chamber 42 to the cross-sectional area of the minimum flow area in the reference passage 44 is less than 1,800:1. One representative but not limiting example includes a 0.6 mm diameter restriction in the reference passage 44 and a diaphragm surface area of 25.4 mm. In other implementations, the ratio may be less than 250:1, or 50:1, or even 10:1.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A fuel and air supply device for an engine, comprising:
a carburetor having a fuel metering assembly including a fuel metering diaphragm that defines at least part of a reference chamber;
a scavenging air assembly including an air passage and an air valve within the passage and moveable to alter air flow through the air passage; and
a reference passage communicating at one end with the air passage at a location upstream of the air valve and at its other end with the reference chamber to provide a reference air signal through the reference passage to the reference chamber.

2. The device of claim 1 wherein the reference passage includes a conduit routed externally of the carburetor.

3. The device of claim 1 wherein the reference passage includes a passage routed internally within the carburetor.

4. The device of claim 3 wherein the reference passage includes a passage extending through a portion of a body defining the air passage.

5. The device of claim 1 wherein the reference passage has a portion that is routed internally of the carburetor and a portion that is routed externally of the carburetor.

6. The device of claim 1 wherein a ratio of the surface area of the fuel metering diaphragm exposed to the reference chamber to the cross-sectional area of the minimum restriction in the reference passage is less than 1,800:1.

7. The device of claim 1 wherein the ratio is less than 250:1.

8. The device of claim 1 wherein said one end of the reference passage that communicates with the air passage at a location upstream of the air valve is located adjacent to the air valve without any other component between said one end of the reference passage and the air valve.

9. The device of claim 8 wherein said one end of the reference passage that communicates with the air passage at a location upstream of the air valve is adapted to be located downstream of a filter through which air flows prior to reaching the air valve.

10. The device of claim 1 which also includes a filter housing and wherein a portion of the reference passage is defined by or within the filter housing.

11. The device of claim 1 which also includes a filter through which air flows prior to the air passage and wherein the reference passage communicates at said one end with a location downstream of the filter

12. A fuel and air supply device for an engine, comprising:
a fuel and air mixing passage from which a fuel and air mixture is delivered to an engine;
a fuel metering assembly including a fuel metering diaphragm that defines at least part of a reference chamber;
a scavenging air assembly including an air passage through which a supply of air is provided to an engine;
a filter through which air flows to the air passage; and
a reference passage communicating at one end with a location downstream of the filter at its other end with the reference chamber.

13. The device of claim 12 wherein a ratio of the surface area of the fuel metering diaphragm exposed to the reference chamber to the cross-sectional area of the minimum flow area in the reference passage is less than 1,800:1.

14. The device of claim 12 wherein a ratio of the surface area of the fuel metering diaphragm exposed to the reference chamber to the cross-sectional area of the minimum flow area in the reference passage is less than 50:1.
